(19) United States
(12) Patent Application Publication
(10) Pub. No.: US 2003/0046575 A1
(43) Pub. Date: Mar. 6, 2003

(54) Digital identity information cards

(75) Inventors: Kulvir Singh Bhogal, Fort Worth, TX (US); Nizamudeen Ishmael JR., Austin, TX (US); Javid Jameossanaie, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/942,755

(22) Filed: Aug. 30, 2001

(51) Int. Cl. H04L 9/32

(52) U.S. Cl. 713/200

(57) ABSTRACT

A method, program, and system for receiving personal identification information by means of a telecommunication device are provided. The invention comprises sending a communication transmission, and concurrent with receiving the communication transmission, sending a second transmission, wherein the second transmission contains personal identification information about the party sending the communication transmission. This personal identification information is independent of the identity of the device used to send the communication transmission and may include such information as name, telephone number, business name, address, email, and fax.

### BACKGROUND OF THE INVENTION

1. Technical Field

The present invention relates generally to telecommunications systems, and more specifically to the transmission of personal identification information.

2. Description of Related Art

Currently, when one is calling a person on a phone, one often needs to leave a phone or pager number, email address, fax number, or other personal identification information. It is often difficult, if not impossible, to type in such data (usually on a non-user friendly keypad), while talking to the person at the other end. This task becomes even more difficult when the person trying to save the information is driving.

Furthermore, current automatic identification approaches, such as caller-ID, are limited as to the information that is downloaded, and are associated with specified hardware, not persons.

Therefore, it would be desirable to have a method for downloading a pre-defined set of personal identification data, which can be sent to and from a plurality of locations and communication devices.

### SUMMARY OF THE INVENTION

The present invention provides a method, program and system for receiving personal identification information by means of a telecommunication device. The invention comprises sending a communication transmission, and concurrent with receiving the communication transmission, sending a second transmission, wherein the second transmission contains personal identification information about the party sending the communication transmission. This personal identification information is independent of the identity of the device used to send the communication transmission and may include such information as name, telephone number, business name, address, email, and fax.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a system diagram illustrating a plurality of interconnected heterogeneous networks in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4A depicts a diagram illustrating a mobile phone in accordance with a preferred embodiment of the present invention;

FIG. 4B depicts a block diagram illustrating the hardware configuration of mobile phone 400 in accordance with a preferred embodiment of the present invention;

FIG. 5 depicts a pictorial diagram illustrating a digital identity information “card” in accordance with the present invention;

FIG. 6, a flowchart illustrating the process of creating and sending a digital identity information card is depicted in accordance with the present invention; and

FIG. 7 depicts a flowchart illustrating the process of receiving and saving a digital identity information card in accordance with the present invention.

### DETAILED DESCRIPTION OF THE PREFERRED EMBODIMENT

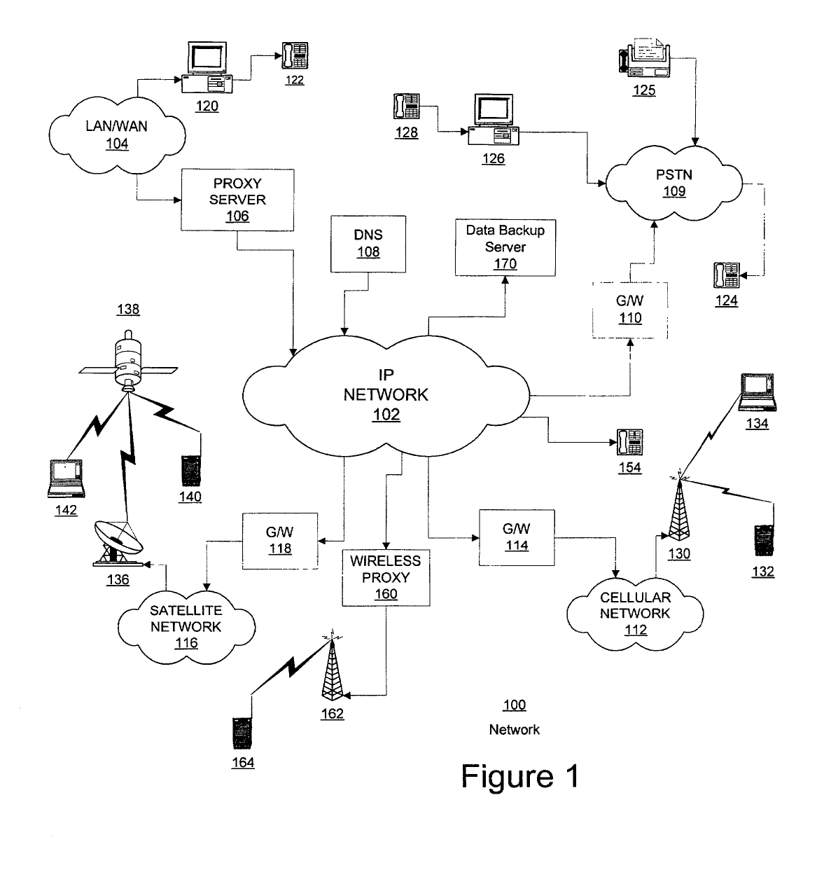

With reference now to the figures, and in particular with reference to FIG. 1, a system diagram illustrating a plurality of interconnected heterogeneous networks in which the present invention may be implemented is depicted. As illustrated, an Internet Protocol (IP) network 102, a Local Area Network (LAN)/Wide Area Network (WAN) 104, the Public Switched Telephone Network (PSTN) 109, a cellular wireless network 112, and a satellite communication network 116 make up the plurality of heterogeneous networks serviced by the personal mobility system of the present invention.

IP network 102 may be the publicly available IP network, a private IP network, or a combination of public and private IP networks. In any case, IP network 102 operates according to the Internet Protocol and routes packets among its many switches and through its many transmission paths. IP networks are generally known in the art to be expandable, fairly easy to use and heavily supported. Coupled to IP network 102 is a Domain Name Server (DNS) 108 to which queries may be sent, such queries each requesting an IP address based upon a Uniform Resource Locator (URL). IP network 102 supports 32 bit IP addresses as well as 128 bit IP addresses, which are currently in the planning stage.

LAN/WAN 104 couples to IP network 102 via a proxy server 106 (or another connection). LAN/WAN 104 may operate according to various communication protocols, such as the Internet Protocol, the Asynchronous Transfer Mode (ATM) protocol, or other known packet switched protocols. Proxy server 106 serves to route data between IP network 102 and LAN/WAN 104. A firewall that precludes unwanted communications from entering LAN/WAN 104 may also be located at the location of proxy server 106.

Computer 120 couples to LAN/WAN 104 and supports communications with LAN/WAN 104. Computer 120 may employ the LAN/WAN and proxy server 106 to communicate with other devices across IP network 102. Such communications are generally known in the art and will not be further described herein except to expand upon the teachings of the present invention. As is also shown, phone 122 couples to computer 120 and may be employed to initiate IP Telephony communications with another phone or voice terminal using IP Telephony. In such an IP telephony system, a gatekeeper is deployed by a service provider to manage IP telephony for its users. An IP phone 154 connected to IP network 102 (or other phone, e.g., phone 124) may communicate with phone 122 using IP telephony.

PSTN 109 is a circuit switched network that is primarily employed for voice communications, such as those enabled by a standard phone 124. However, PSTN 109 also supports the transmission of data. Data transmissions may be supported to a tone based terminal, such as a FAX machine 125, to a tone based modem contained in computer 126, or to another device that couples to PSTN 109 via a digital connection, such as an Integrated Services Digital Network (ISDN) line, an Asynchronous Digital Subscriber Line (ADSL), or another digital connection to a terminal that supports such a connection. As illustrated, a voice terminal, such as phone 128, may couple to PSTN 109 via computer 126 rather than being supported directly by PSTN 109, as is the case with phone 124. Thus, computer 126 may support IP telephony with voice terminal 128, for example.

Cellular network 112 supports wireless communications with terminals operating in its service area (which may cover a city, county, state, country, etc.). As is known, cellular network 112 includes a plurality of towers, e.g., 130, that each service communications within a respective cell. Wireless terminals that may operate in conjunction with cellular network 112 include wireless handsets 132 and wirelessly enabled laptop computers 134, for example. Wireless handsets 132 could be, for example, personal digital assistants, wireless or cellular telephones, or two-way pagers. Cellular network 112 couples to IP network 102 via gateway 114.

Wireless handsets 132 and wirelessly enabled laptop computers 134 may communicate with cellular network 112 using a wireless application protocol (WAP). WAP is an open, global specification that allows mobile users with wireless devices, such as, for example, mobile phones, pagers, two-way radios, smartphones, communicators, personal digital assistants, and portable laptop computers, to easily access and interact with information and services almost instantly. WAP is a communications protocol and application environment and can be built on any operating system including, for example, Palm OS, EPOC, Windows CE, FLEXOS, OS/2, and JavaOS. WAP provides interoperability even between different device families.

WAP is the wireless equivalent of Hypertext Transfer Protocol (HTTP) and Hypertext Markup Language (HTML). The HTTP-like component defines the communication protocol between the handheld device and a server or gateway. This component addresses characteristics that are unique to wireless devices, such as data rate and round-trip response time. The HTML-like component, Wireless Markup Language (WML), defines new markup and scripting languages for displaying information to and interacting with the user. This component is highly focused on and aware of the limited display size and limited input devices available on small, handheld devices. For example, a typical cell phone may have only a 4×10-character display with 16-gray levels and only a numeric keypad plus up/down volume keys.

Cellular network 112 operates according to an operating standard, which may be the Advanced Mobile Phone System (AMPS) standard, the Code Division Multiple Access (CDMA) standard, the Time Division Multiple Access (TDMA) standard, or the Global System for Mobile Communications or Groupe Speciale Mobile (GSM), for example. Independent of the standard(s) supported by cellular network 112, cellular network 112 supports voice and data communications with terminal units, e.g., 132 and 134.

Satellite network 116 includes at least one satellite dish 136 that operates in conjunction with a satellite 138 to provide satellite communications with a plurality of terminals, e.g., laptop computer 142 and satellite handset 140. Satellite handset 140 could also be a two-way pager. Satellite network 116 may be serviced by one or more geosynchronous orbiting satellites, a plurality of medium earth orbit satellites, or a plurality of low earth orbit satellites. In any case, satellite network 116 services voice and data communications and couples to IP network 102 via gateway 118.

Wireless Proxy 160 is coupled to IP network 102 and is coupled to a plurality of towers, e.g., 162, which each provide wireless communications with wireless devices such as wireless device 164. Wireless Proxy 160 provides access to IP network 102 to wireless device 164, such as a personal digital assistants (PDA) or a wireless telephone, that may require proprietary or other special protocols in order to communicate with IP network 102. For example, wireless proxy server 160 may be a 3Com server utilizing 3Com protocols for communicating with a Palm VII, a handheld portable computing device available from 3Com Corporation in Santa Clara, Calif.

In a preferred embodiment of the present invention, wireless proxy 160 is a 3Com proxy server supporting communications with a Palm VII personal organizer and portable computing device 164 is a Palm VII personal organizer. In this embodiment, communications between wireless proxy server 160 and portable computing device 164 is facilitated by the use of Palm Query Applications (PQAs). A PQA is like a mini-Web site that resides on portable computing device 164. That is, a PQA is a special kind of record database. A typical PQA contains an HTML form or a list of hyperlinks that request additional information either locally—on personal computing device 164—or remotely—on the Internet.

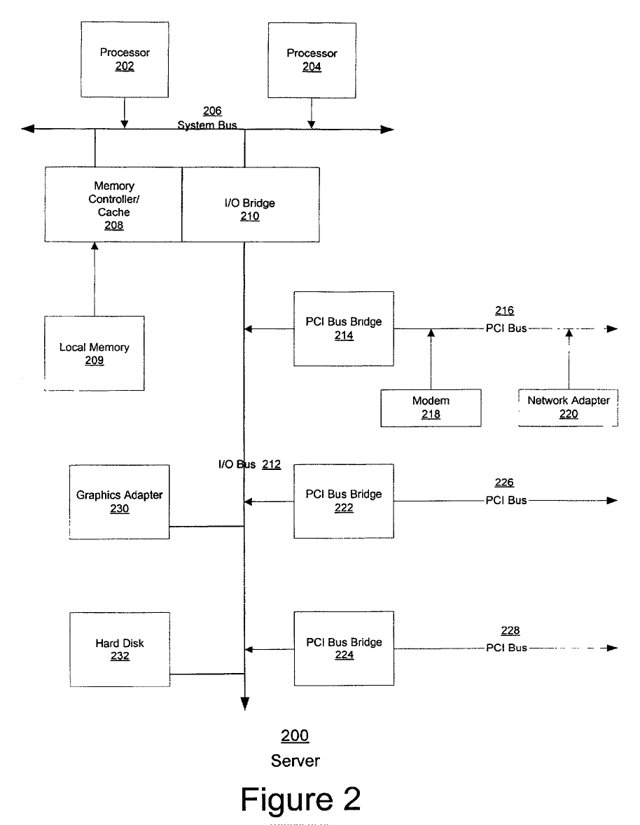

Referring to FIG. 2, a block diagram of a data processing system that may be implemented as a server is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

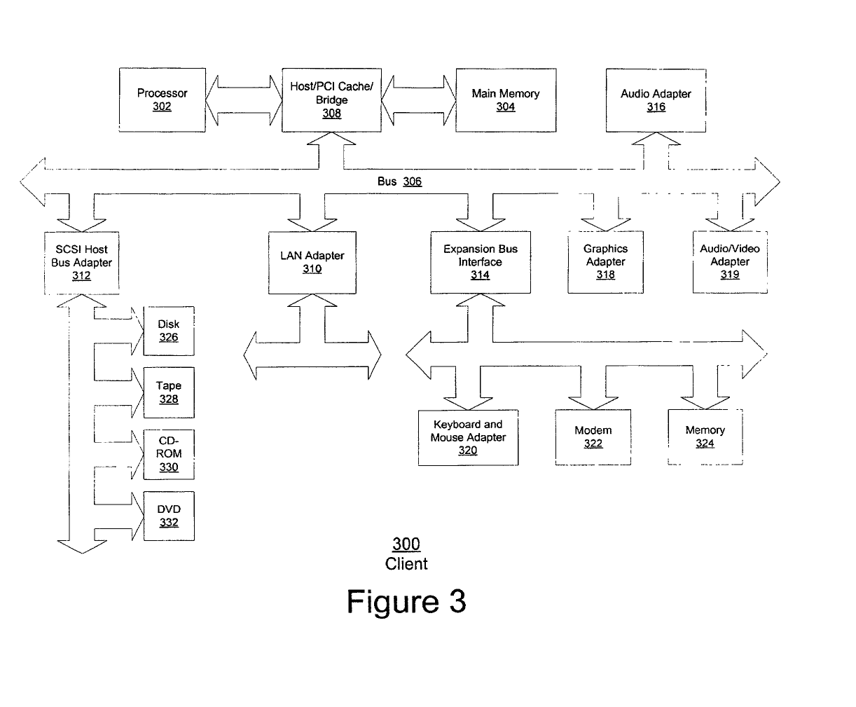

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

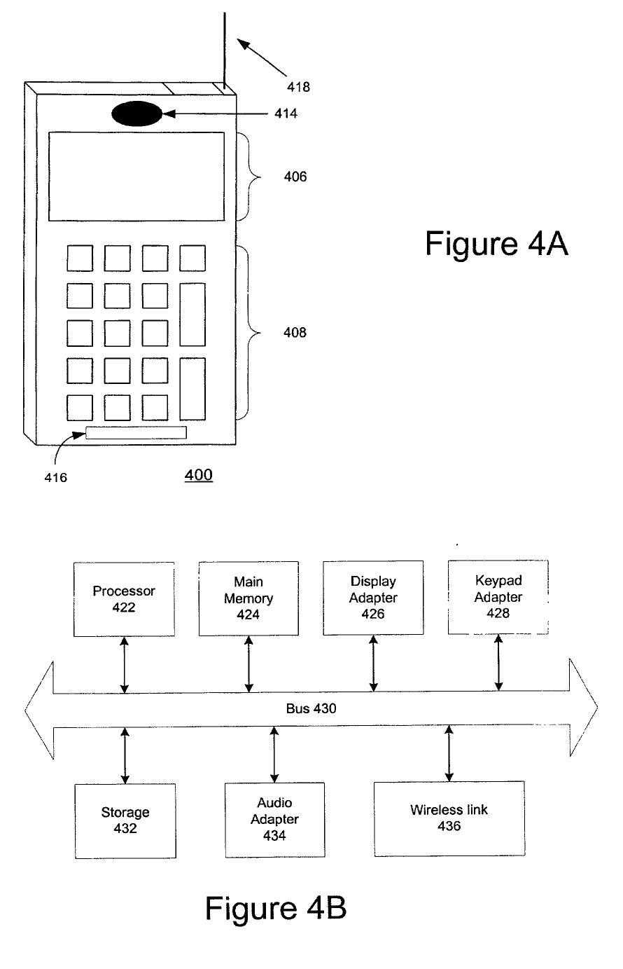

With reference now to FIG. 4A, a diagram illustrating a mobile phone is depicted in accordance with a preferred embodiment of the present invention. Mobile phone 400 includes a display 406 for presenting textual and graphical information. Display 406 may be a known display device, such as a liquid crystal display (LCD) device.

Mobile phone 400 may also include keypad 408, speaker 414, and microphone 416. The keypad may be used to enter, for example, telephone numbers, user identification information, and commands for interacting with the interface. Audio feedback may be presented via speaker 414. In addition to normal voice conversation, feedback may include other information, for example, an audio description of user location (as determined by positioning technologies). Microphone 416 can be used not only for voice conversation, but also for entering specific voice commands for voice actuated functions.

Mobile phone 400 also includes antenna 418, which is necessary for establishing wireless communication links with remote transmitting towers.

Turning now to FIG. 4B, a block diagram illustrating the hardware configuration of mobile phone 400 is shown in accordance with a preferred embodiment of the present invention. FIG. 4B illustrates the increasing sophistication of modern mobile phone designs.

Mobile phone 400 employs bus architecture. Processor 422 and main memory 424 are connected to bus 430. Display adapter 426, keypad adapter 428, storage 432, and audio adapter 434 are also connected to bus 430. Mobile phone 400 also includes wireless link 436 connected to bus 430. Those of ordinary skill in the art will appreciate that the hardware in FIG. 4B may vary depending on the implementation. Other internal hardware or peripheral devices may be used in addition to or in place of the hardware depicted in FIG. 4B.

Mobile phone 400 might rely on Wireless Application Protocol (WAP) for facilitating communications. WAP is a standard for providing wireless phones, pagers and other handheld devices with secure access to e-mail and text-based Web pages. WAP provides a complete environment for wireless applications that includes a wireless counterpart of TCP/IP and a framework for telephony integration such as call control and phone book access. WAP features WML. It also uses WMLScript, a compact JavaScript-like language that runs in limited memory. WAP also supports handheld input methods such as input via keypad and input via voice, facilitated by voice recognition. Independent of the air interface, WAP runs over all the major wireless networks in place. It is also device independent, requiring only a minimum functionality in the unit so that it can be used with a myriad of phones and handheld devices.

The depicted example in FIG. 4B and above-described examples are not meant to imply architectural limitations.

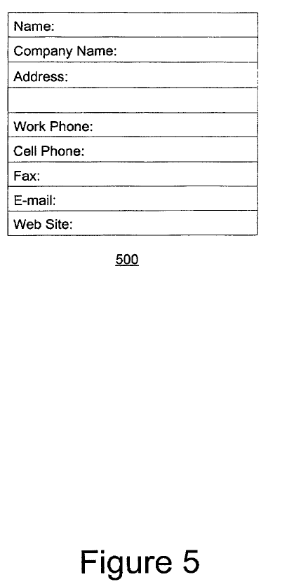

Referring to FIG. 5, a pictorial diagram illustrating a digital identity information “card” is depicted in accordance with the present invention. The present invention allows a sender to send a digital identification card 500 to a second party. It should be pointed out that the digital identity card can be sent to a land-line telephone, cell phone, pager, voicemail/memo service or email account, which may be accessed via PDA or other pervasive computing device. However, for the sake of simplicity, the present example will be limited to use with cellular phones.

As shown in FIG. 5, the digital identity card contains several fields for personal identification information, similar to a paper business card. Much of the information contained in the digital card 500 relates to contact information, which can be customized to the user's needs. Examples information include name, business name, personal and business phones numbers, email, mailing address, fax number, pager number, and web site address. Because many people now have multiple communication means available to them, and multiple contact channels, it is convenient to have a reference to all of them in one place. Physical business cards are the traditional means of conveying all of the necessary information. However, exchange of such cards requires the parties to be in each other's physical presence. By contrast, digital card 500 can easily be sent over a cell phone transmission.

Current approaches to telephone identification are very limited. The best known is the caller-ID service. Caller-ID is sent to the receiving telephone before the receiving party answers the phone, and is limited to identifying the name and telephone number of the calling party. In addition, the identity transmitted by caller-ID is based on the device/location of the calling party. For example, if a personal is making a call from a friend's phone, caller-ID will send the name and phone number of the friend who owns the phone, not the person actually making the call. In other words, caller-ID does not really inform the receiving party as to who is calling, as much as from where that person is calling.

The digital identity cards provided by the present invention are independent of the device being used, and may be loaded into and sent from the phone being used at the moment, as explained in more detail below.

Examples of standards that may be used for the digital identification cards include Extensible Markup Language (XML), Wireless Markup Language (WML), Handheld Device Markup Language (HDML), or any similar programming language which may be used with pervasive computing and communication devices.

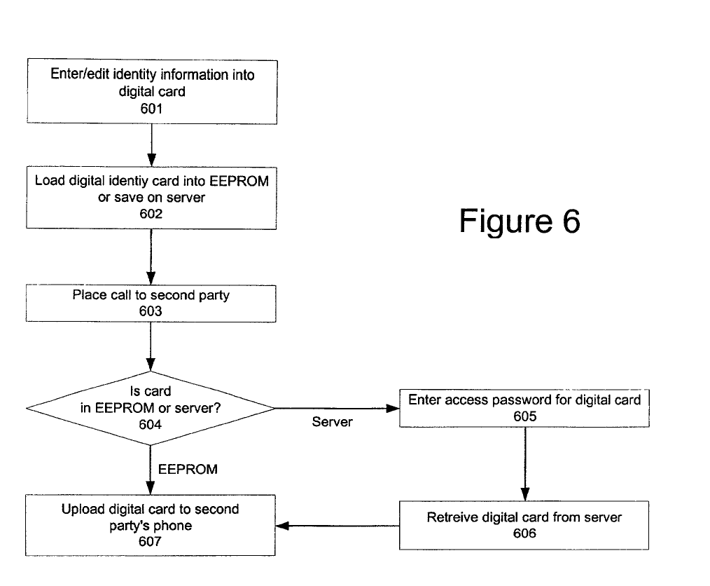

Referring now to FIG. 6, a flowchart illustrating the process of creating and sending a digital identity information card is depicted in accordance with the present invention. The user begins by entering his or her personal identification information into the information fields of the digital card, such as those illustrated in FIG. 5 (step 601). The information may be entered by means of a cell phone keypad, personal computer, or any pervasive computing device. The user may then either load the digital card into local Electrically Erasable Programmable Read Only Memory (EEPROM) or store the digital card on a server, to be retrieved at a later time (step 602). Storing the digital card on a server allows the user to retrieve and load the card into any cell phone on the spot.

At a later point in time, the user places a call to a second party (step 603). During the phone call, the user may wish to send his or her digital card to the second party. How the user does this will depend on whether the digital card has already been loaded into the phone being used or is stored on a server (step 604). If the card is already in local EEPROM, the user uploads the card to the second party's phone (step 607). Multiple card's may be stored in EEPROM. For example, a husband and wife might use the same phone but have different contact information. In this case, the user will pick his or her respective profile, which will send the corresponding card information.

If the card is not loaded into the phone, the user must retrieve it from the server. The user enters an ID or password, which the server associated with a file (step 605). The digital card is retrieved from the server file (step 606), and may then be uploaded to the second party's phone (step 607).

Digital cards may also be uploaded to voicemail accounts. It is not necessary in order to send the card for the receiving party to answer the phone.

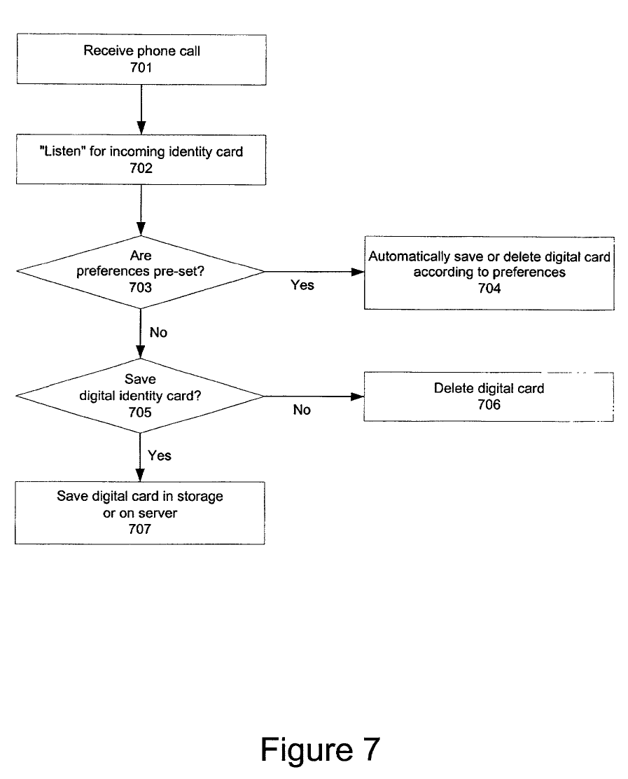

Referring to FIG. 7, a flowchart illustrating the process of receiving and saving a digital identity information card is depicted in accordance with the present invention. The phone receives the incoming phone call (step 701). Then phone (during operations) “listens” for incoming identity cards, which are sent during the call (step 702). This information can be passed during a cell phone conversation and is transmitted at an inaudible frequency. The average human has a hearing range of 20 Hz to 12,000-15,000 Hz. The present invention actively “listens” for frequencies at a lower or higher frequency than that of the human hearing range. “Listening” means that the phone will provide a response to certain received frequencies, which is well known in the art. For example, the phone used in the present invention rings when it “hears” an incoming call. Thus, cell phones are actively “listening” for incoming phone calls at inaudible frequencies. Phone conversations are then converted into analog signals at audible frequencies. The present invention applies a similar approach for receiving digital information cards. The phone actively listens for a start signal, which signifies the start of transmission of a digital card, and an end signal, which marks the end of transmission of the card.

New phones can be built that can detect an incoming digital identification card, or changes can be made at the service provider level to facilitate the needs of the present invention. Because the digital cards are sent via inaudible frequencies, traditional land-line legacy phones will ignore the incoming signal, and consider it to be part of normal audio transmission. However, mobile phones and land-line phones equipped to recognize the digital cards will know how to handle the incoming signal. To overcome this limitation of older technology, existing phones (both mobile and land-line) may be patched, via software upgrades, to listen for and interpret these inaudible audio signals.

It should be noted that receiving the call is not restricted to actually answering the phone. As noted above, a voicemail account may receive the call and the digital card. To facilitate this functionality, the service provider will have to support saving of the transmission of digital cards during voice mail account interaction.

The receiving phone recognizes the reception of digital card and determines if the user has pre-set preferences as to saving incoming digital cards (step 703). If the user does have pre-set preferences, the phone automatically saves the incoming digital card, deletes the digital card, or writes over a preexisting digital card with the same caller identity (e.g., as determined by first and last name), according to the preferences (step 704). For example, a user might set the phone to automatically save all incoming digital cards.

If the user does not have pre-set preferences, the phone prompts the user to save the entry (step 705). The user can press a single button to either save or not save the incoming digital card. If the user chooses not to save the card, the card is simply deleted (step 706). If the user does choose to save the card, it is either saved in local storage or sent to a server and saved in the user's file (step 707). The transmission and download to the digital identification cards does not interrupt phone conversations. However, a status indication may be presented to the user's LCD display to inform the user about the progress of digital card transmission. For example, text prompts like “Digital information card received from John Smith” can be displayed to the phone user.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for receiving personal identification information by means of a telecommunication device, the method comprising:
receiving a communication transmission; and
concurrent with receiving the communication transmission, receiving a second transmission, wherein the second transmission contains personal identification information about the party sending the communication transmission, and wherein the personal identification information is independent of the identity of the device used to send the communication transmission.

2. The method according to claim 1, wherein the personal identification information includes at least one of the following:
name;
business name;
address;
telephone number;
fax number;
pager number;
email address; and
web site address.

3. The method according to claim 1, wherein the personal identification information is stored on a server.

4. The method according to claim 1, wherein the personal identification information is stored in memory on the sending device.

5. The method according to claim 1, wherein the receiving device is one of the following:
mobile telephone;
land-line telephone;
voicemail system;
PDA; and
pager.

6. A method for sending personal identification information by means of a telecommunication device, the method comprising:
sending a communication transmission; and
concurrent with sending the communication transmission, sending a second transmission, wherein the second transmission contains personal identification information about the party sending the communication transmission, and wherein the personal identification information is independent of the identity of the device used to send the communication transmission.

7. The method according to claim 6, wherein the personal identification information includes at least one of the following:
name;
business name;
address;
telephone number;
fax number;
pager number;
email address; and
web site address.

8. The method according to claim 6, wherein the personal identification information is stored on a server.

9. The method according to claim 6, wherein the personal identification information is stored in memory on the sending device.

10. The method according to claim 6, wherein the receiving device is one of the following:
mobile telephone;
land-line telephone;
PDA; and
pager.

11. A computer program product in a computer readable medium for use in a data processing system, for receiving personal identification information by means of a telecommunication device, the computer program product comprising:
instructions for receiving a communication transmission; and
instructions for receiving a second transmission, concurrent with receiving the communication transmission, wherein the second transmission contains personal identification information about the party sending the communication transmission, and wherein the personal identification information is independent of the identity of the device used to send the communication transmission.

12. The computer program product according to claim 11, wherein the personal identification information includes at least one of the following:
name;
business name;
address;
telephone number;
fax number;
pager number;
email address; and
web site address.

13. The computer program product according to claim 11, wherein the personal identification information is stored on a server.

14. The computer program product according to claim 11, wherein the personal identification information is stored in memory on the sending device.

15. A computer program product in a computer readable medium for use in a data processing system, for sending personal identification information by means of a telecommunication device, the computer program product comprising:
instructions for sending a communication transmission; and
instructions for sending a second transmission, concurrent with sending the communication transmission, wherein the second transmission contains personal identification information about the party sending the communication transmission, and wherein the personal identification information is independent of the identity of the device used to send the communication transmission.

16. The computer program product according to claim 15, wherein the personal identification information includes at least one of the following:
name;
business name;
address;
telephone number;
fax number;
pager number;
email address; and
web site address.

17. The computer program product according to claim 15, wherein the personal identification information is stored on a server.

18. The computer program product according to claim 15, wherein the personal identification information is stored in memory on the sending device.

19. A system for receiving personal identification information by means of a telecommunication device, the system comprising:
a first receiving component which receives a communication transmission; and
a second receiving component which receives a second transmission, concurrent with receiving the communication transmission, wherein the second transmission contains personal identification information about the party sending the communication transmission, and wherein the personal identification information is independent of the identity of the device used to send the communication transmission.
